(19) United States
(12) Patent Application Publication
(10) Pub. No.: US 2023/0241621 A1
(43) Pub. Date: Aug. 3, 2023

(54) DEVICES AND METHODS FOR THE ISOLATION OF PARTICLES

(71) Applicant: BIOACTIVE MATERIALS PTY LTD, Blackburn, Victoria (AU)

(72) Inventors: Lizhong He, Blackburn, Victoria (AU); Ian Edward Dixon, Blackburn, Victoria (AU); Puja Paul, Blackburn, Victoria (AU); Bhuvana Shanbhag, Blackburn, Victoria (AU); Li Ji, Blackburn, Victoria (AU)

(21) Appl. No.: 17/927,547

(22) PCT Filed: May 27, 2021
(86) PCT No.: PCT/AU2021/050514

§ 371 Date: Nov. 23, 2022

(30) Foreign Application Priority Data
May 27, 2020 (AU) 2020901719

(51) Int. Cl. B03B 5/34; B04C 5/081; B04C 5/04; B04C 5/13

(52) U.S. Cl. CPC B03B 5/34; B04C 5/04; B04C 5/13; B04C 5/081

(57) ABSTRACT

Described embodiments generally relate to a hydrocyclone for isolating particles within a fluid. The hydrocyclone comprises an upper conical section defining at least one inlet to receive the fluid, a vortex finder extending into the upper conical section, and an overflow port fluidly connected to the vortex finder and configured to expel a portion of the fluid out of the upper conical section; and a lower conical section defining an underflow port to expel the remaining fluid out of the lower conical section, the lower conical section being fluidly connected to the upper conical section to define a single hollow volume. The shape of the hydrocyclone causes particles smaller than a predetermined size to be isolated by expelling the particles from the overflow port.

### TECHNICAL FIELD

Embodiments generally relate to devices and methods for isolating particles in a fluid. Specifically, embodiments relate to mini hydrocyclones for isolating microparticles and/or nanoparticles in a fluid.

### BACKGROUND

The ability to separate particles in a solution based on the particle size and density is desirable in a number of fields, including manufacturing, water treatment, mineral processing, chemical syntheses, food processing and biomedical analyses. In particular, the separation and isolation of particles in a continuous flow can be advantageous for these processes. While fluidic technology allows for the continuous separation and sorting of particles based on their size and density, known fluidics techniques do not deal well with separating particles of a small size, such as for isolating microparticles and nanoparticles.

It is desired to address or ameliorate one or more shortcomings or disadvantages associated with prior devices and methods for isolating particles, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In this document, a statement that an element may be “at least one of” a list of options is to be understood to mean that the element may be any one of the listed options, or may be any combination of two or more of the listed options.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a hydrocyclone for isolating particles within a fluid, the hydrocyclone comprising:
an upper conical section defining at least one inlet to receive the fluid, a vortex finder extending into the upper conical section, and an overflow port fluidly connected to the vortex finder and configured to expel a portion of the fluid out of the upper conical section; and
a lower conical section defining an underflow port to expel the remaining fluid out of the lower conical section, the lower conical section being fluidly connected to the upper conical section to define a single hollow volume;

wherein the walls of the lower conical section are concave; and
wherein the shape of the hydrocyclone causes particles smaller than a predetermined size to be isolated by expelling the particles from the overflow port.

According to some embodiments, the predetermined size is less than 5 µm. In some embodiments, the predetermined size is less than 1 µm. In some embodiments, the shape of the hydrocyclone causes particles larger than the predetermined size to be expelled from the underflow port.

According to some embodiments, the diameter of the hydrocyclone is between 0.5 mm and 5 mm. In some embodiments, the diameter of the at least one inlet is between 0.25 and 0.71 mm. According to some embodiments, the diameter of the overflow port is between 0.075 and 0.75 mm. In some embodiments, the diameter of the underflow port is between 0.05 and 1.5 mm.

In some embodiments, the upper conical section defines two counter-disposed inlets to receive the fluid.

According to some embodiments, the length of the vortex finder is between 0.5 and 1.67 mm. In some embodiments, the length of the upper conical section is between 1.0 and 3.6 mm. In some embodiments, the length of the lower conical section is between 2 and 98.6 mm.

In some embodiments, the cone shape of the lower conical section is between 0.6 and 1.

In some embodiments, a roughness of the inside of the hydrocyclone is between 3 and 10 µm.

According to some embodiments, the at least one inlet is circular in shape. In some embodiments, the at least one inlet is trapezoidal in shape.

In some embodiments, the hydrocyclone is manufactured by 3D printing.

According to some embodiments, the fluid comprises a biological fluid or a fraction thereof or contains biological material. In some embodiments, the particles comprise at least one of a nanoparticle, a liposome, a cell, a secreted extracellular vesicle, virus particle, viral vector, virus-lie particle, protein aggregate, nucleic acid aggregate, or any combination thereof.

Some embodiments relate to a system for isolating particles within a fluid, the system comprising:
a feed tank for holding a fluid;
the hydrocyclone of some other embodiments; and
a pump for receiving the fluid from the feed tank and pumping the fluid into the hydrocyclone.

Some embodiments further comprise a recycling tube for channelling fluid from the underflow port of the hydrocyclone into the feed tank.

In some embodiments, the pump is configured to pump the fluid into the hydrocyclone at a velocity between 9.6 and 16.25 m/s.

Some embodiments relate to a method for isolating particles within a fluid, the method comprising:
pumping fluid into the at least one inlet of the hydrocyclone of some other embodiments; and
collecting the isolated particles from the overflow port of the hydrocyclone.

In some embodiments, pumping fluid into the at least one inlet of the hydrocyclone comprises pumping fluid into the at least one inlet of the hydrocyclone at a velocity between 9.6 and 16.25 m/s.

Some embodiments further comprise collecting fluid from the underflow port of the hydrocyclone, and subsequently re-pumping the collected fluid into at least one inlet of the hydrocyclone or into the feed tank.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Embodiments are described in further detail below, by way of example and with reference to the accompanying drawings, in which:

FIG. 1 illustrates a hydrocyclone according to some embodiments;

FIG. 2 illustrates an alternative hydrocyclone according to some embodiments;

FIG. 3 shows a diagram of dimensions of the hydrocyclone of FIG. 1or FIG. 2;

FIG. 4A shows the inlet of the hydrocyclone of FIG. 2 in further detail;

FIG. 4B shows the inlet of the hydrocyclone of FIG. 1 in further detail;

FIG. 5 shows a processing system for isolating nanoparticles incorporating the hydrocyclone of FIG. 1;

FIG. 6 shows an alternative processing system for isolating nanoparticles incorporating the hydrocyclone of FIG. 1;

FIG. 7 shows a diagrammatic representation of a particle moving within the hydrocyclone of FIG. 1or FIG. 2;

FIG. 8 shows a processing system for isolating nanoparticles with recycling incorporating the hydrocyclone of FIG. 1;

FIG. 9 shows a graph demonstrating the results of using the hydrocyclone of FIG. 1 to isolate microparticles in ginger juice;

FIG. 10 shows a processing system for isolating nanoparticles incorporating two hydrocyclones of FIG. 1 in series;

FIG. 11A shows a graph demonstrating the results of using a first hydrocyclone of FIG. 10 to isolate microparticles in whey;

FIG. 11B shows a graph demonstrating the results of using a second hydrocyclone of FIG. 10 to isolate microparticles in whey using the overflow fluid from the first hydrocyclone of FIG. 10 as the feed;

FIG. 12A shows a graph demonstrating the results of using the hydrocyclone of FIG. 1 to isolate microparticles in whey without recycling;

FIG. 12B shows a graph demonstrating the results of using the hydrocyclone of FIG. 1 to isolate microparticles in whey with recycling;

FIG. 13 shows a further graph demonstrating the results of using the hydrocyclone of FIG. 1 to isolate microparticles in whey with recycling;

FIG. 14A shows a TEM image of a feed stream of the hydrocyclone of FIG. 1 comprising whey;

FIG. 14B shows a TEM image of an overflow stream of the hydrocyclone of FIG. 1 comprising whey;

FIG. 15A shows a TEM image of a feed stream of the hydrocyclone of FIG. 1 comprising ginger juice; and

FIG. 15B shows a TEM image of an overflow stream of the hydrocyclone of FIG. 1 comprising ginger juice.

### DETAILED DESCRIPTION

Embodiments generally relate to devices and methods for isolating particles in a fluid. Specifically, embodiments relate to mini hydrocyclones for isolating microparticles and nanoparticles in a fluid.

Prior known devices for separating particles in a fluid struggle to separate particles of small sizes, such as microparticles and nanoparticles. In particular, prior hydrocyclones designed for the separation of small particles were not able to achieve laminar flow, and so experienced decreased efficiency as particle sizes got smaller. Embodiments described below relate to a new hydrocyclone for isolation of microparticles and nanoparticles in a fluid. Specifically, the described embodiments relate to hydrocyclones having particular geometry and operating parameters. Some embodiments relate to hydrocyclones that allow for a decrease in the Reynolds number and a decrease of the turbulence within the hydrocyclone. Some described embodiments allow laminar flow to occur within the hydrocyclone, increasing efficiency in the isolation of the particles, despite previous data suggesting the Reynolds number of such hydrocyclones would not allow for laminar flow. Some embodiments described below therefore allow for particles to be isolated that are two to three orders of magnitude smaller than previously possible, whilst also improving the separation efficiency.

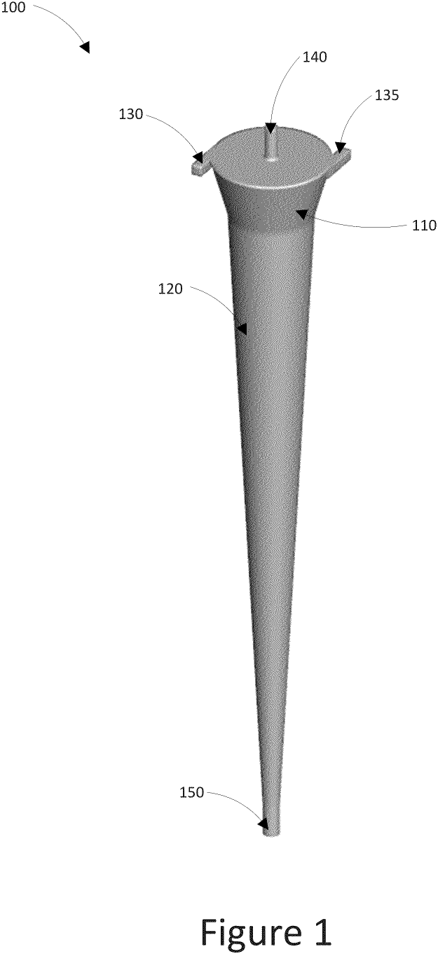

FIG. 1 shows a hydrocyclone 100 for isolating particles within a fluid. The particles may be microparticles or nanoparticles in some embodiments. The fluid may comprise a gas or a liquid. According to some embodiments, hydrocyclone 100 may be particularly used for isolating particles within a fluid where the density of the fluid is lower than the density of the particles.

Hydrocyclone 100 is a double cone hydrocyclone, with a body comprising an upper conical section 110 and a lower conical section 120. Upper conical section 110 and lower conical section 120 are of a frustoconical or truncated conical shape, are hollow, and together define a single volume, being fluidly coupled at their intersection.

Upper conical section 110 comprises inlets 130 and 135. While two inlets 130 and 135 are pictured, some embodiments comprise only one inlet, while some embodiments may comprise more than two inlets. Illustrated inlets 130 and 135 are counter-disposed on opposite sides of the upper edge of upper conical section 110, and are positioned tangential to the edge of conical section 110. According to some embodiments, inlets 130 and 135 may be unevenly spaced around the upper edge of upper conical section 110. In the illustrated embodiment, inlets 130 and 135 are arranged to direct fluid entering inlet 130 or 135 in a clockwise direction within upper conical section 110. According to some embodiments, inlets 130 and 135 may be arranged to direct fluid entering inlet 130 or 135 in an anti-clockwise direction within upper conical section 110.

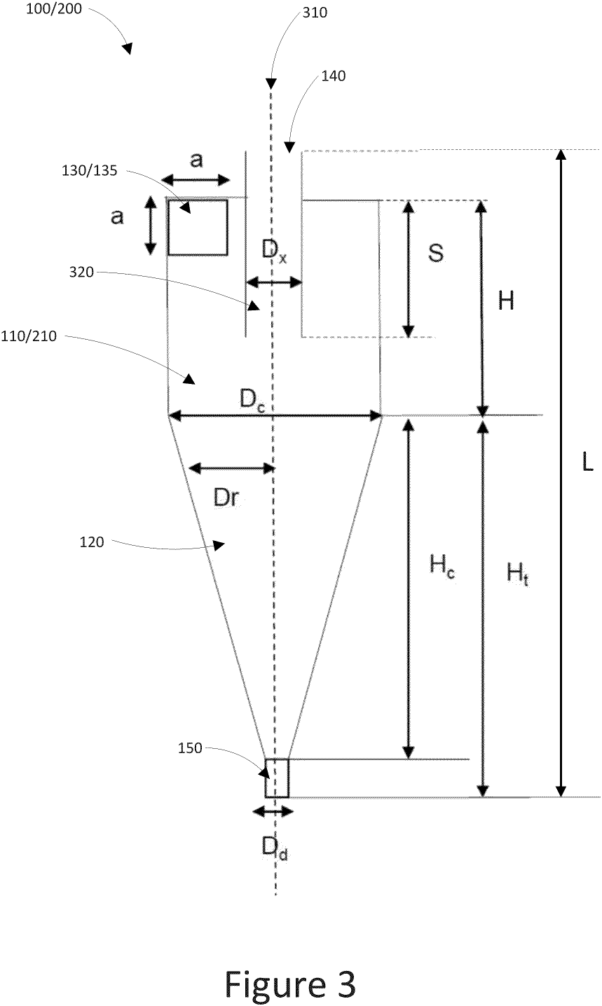

Upper conical section 110 further comprises an accept or overflow port 140. Overflow port 140 is positioned perpendicular to the top surface of upper conical section 110, and is configured to direct an outlet stream of particles upwards and out of hydrocyclone 100. According to some embodiments, upper conical section 110 comprises a vortex finder (shown in FIG. 3) extending down into the centre of upper conical section 110 from the top surface of upper conical section 110, and the vortex finder extends upward and becomes the overflow port 140.

The lower end of lower conical section 120 comprises a reject or underflow port 150. Underflow port 150 is configured to direct an outlet stream of particles downward and out of hydrocyclone 100.

In operation, hydrocyclone 100 can be used to separate particles within a fluid. Specifically, a fluid comprising particles can be injected into inlets 130 and 135. The fluid enters upper conical section 110 of hydrocyclone 100 tangentially and forms a circulating path with a net inward flow along the vertical axis of hydrocyclone 100. Larger, heavier and/or denser particles are pushed towards the walls of the upper conical section 110 and move downward into lower conical section 120. Eventually, these particles exit out of underflow port 150, along with a proportion of the fluid. The proportion of fluid that exits out of underflow port 150 is defined by the split ratio of the hydrocyclone, and the volume of fluid that exits out of underflow port 150 is defined by the split ratio and the feed flow rate of the hydrocyclone. Smaller, lighter and/or less dense particles are pulled inward into a vortex created along the vertical axis of hydrocyclone 100 and move upward, eventually exiting out of overflow port 140, along with the remaining fluid. The proportion of fluid that exits out of overflow port 140 is defined by the split ratio of the hydrocyclone, and the volume of fluid that exits out of overflow port 140 is defined by the split ratio and the feed flow rate of the hydrocyclone.

The split ratio R_{f} of hydrocyclone 100/200 may be defined as the ratio of the flowrate of the underflow port 150 Qᵤ to the flowrate of the inlet(s) 130/135 Qᵢ, using the equation:

$${R}_{f} = \frac{{Q}_{u}}{{Q}_{i}}$$

The split ratio is affected by both geometrical parameters of hydrocyclone 100/200, and operational parameters including the inlet flowrate, pressure and feed concentration. As the inlet flowrate increases, the pressure energy of the flow filed increases, which expands the air core or inner vortex volume within hydrocyclone 100/200 and restricts flow to underflow port 150. This results in a change to the split ratio. For example, the split ratio may decrease. With increases in pressure at inlet(s) 130/135, the pressure drop increases which expands the air core or inner vortex volume within hydrocyclone 100/200 and restricts flow to underflow port 150. This also results in a change to the split ratio. For example, the split ratio may decrease. When the feed concentration is altered, the flow to underflow port 150 may change proportionally. This results in a corresponding change to the split ratio. For example, if the feed concentration increases, the flow to underflow port 150 also increases, resulting in an increase of the split ratio.

According to some embodiments, hydrocyclone 100 may be designed to cause microparticles to be expelled from underflow port 150, and to cause nanoparticles to be expelled from overflow port 140. According to some embodiments, hydrocyclone 100 may be designed to cause particles bigger than a predetermined threshold size to be expelled from underflow port 150, and to cause particles smaller than the predetermined threshold size to be expelled from overflow port 140. In some embodiments, the predetermined size may be 5 µm or less. In some embodiments, the predetermined size may be 1 µm. The predetermined threshold size may be referred to as the cut size of the hydrocyclone, and may be broadly set by changing the geometry of hydrocyclone, and particularly the body diameter of the hydrocyclone. Generally, the smaller the diameter, the smaller the cut size. The cut size may be defined as the size of a particle which will be expelled by the overflow port 140 at 50% efficiency. According to some embodiments, a hydrocyclone with a diameter of 2.5 mm may have a cut size of 5 µm.

According to some embodiments, hydrocyclone 100 may be designed to cause particles denser than a predetermined threshold density to be expelled from underflow port 150, and to cause particles less dense than the predetermined threshold density to be expelled from overflow port 140.

The separation of the smaller and bigger particles within hydrocyclone 100 is based on the terminal settling velocity of the solid particles in a centrifugal field. Specifically, particles are separated by the accelerating centrifugal force based on their size, shape, and density. A drag force moves slower settling particles to a low-pressure zone along an inner vortex formed within hydrocyclone 100. The vortex carries the slower settling particles upward through a vortex finder (shown in FIG. 3) to overflow port 140.

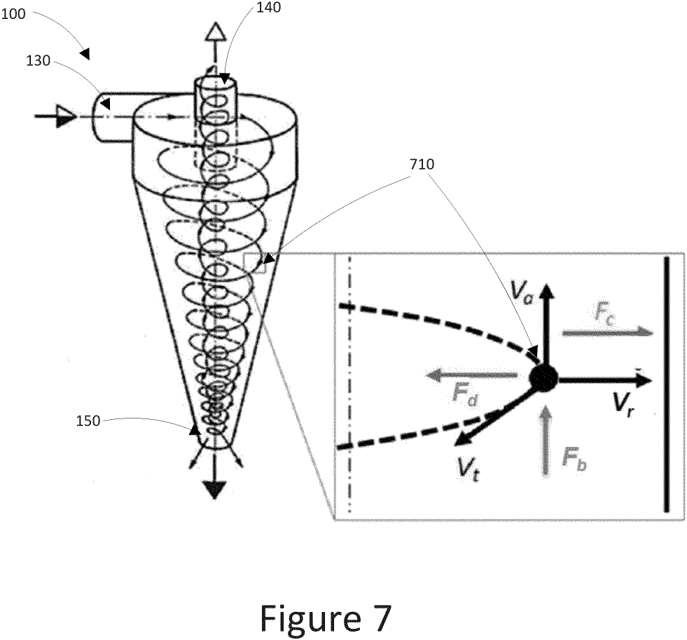

FIG. 7 shows a diagrammatic representation of a particle 710 moving within a hydrocyclone 100. Hydrocyclone 100 includes an inlet 130, an overflow port 140 and an underflow port 150. Particle 710 has a diameter Dₚ, density ρₚ and mass m. Particle 710 travelling within hydrocyclone 100 will have an axial velocity Vₐ, a tangential velocity Vₜ, and a radial velocity Vᵣ. When particle 710 is travelling within hydrocyclone 100 at a radial distance of r, particle 710 will have three forces acting on it, being a centrifugal force Fc in an outward radial direction due to the tangential velocity vₜ; a buoyant force F_{b} in an inward radial direction that is due to the density difference of the fluid ρ_{f} and the particle ρ_{p;} and a drag force F_{d} having the direction inward or outward, depending upon the direction of the radial velocity vᵣ of the particle, so that it always opposes the particle movement due to the fluid viscosity µ. The drag force depends on the particle shape and size as well as the turbulence intensity of the flow. Equations describing each of these forces are set out below:

$${F}_{c} = m \frac{{v}_{d} {}^{2}}{r} = \frac{π {D}_{p} {}^{3}}{6} \frac{{v}_{t} {}^{2}}{r} {ρ}_{p}$$

$${F}_{b} = - \frac{π {D}_{p} {}^{3}}{6} \frac{{v}_{t} {}^{2}}{r} {ρ}_{f}$$

$${F}_{d} = - 3 π {D}_{p} μ {v}_{r}$$

At steady state operation, the net force on the particle will be zero:

$${F}_{c} + {F}_{b} + {F}_{d} = 0$$

For a hydrocyclone 100 with a diameter of D_{c}, this means that the size of the particle that can be separated out can be calculated as

$${D}_{p} = 3 {\left(\frac{μ {v}_{r} \text{Dc}}{{v}_{t} {}^{2} \left({ρ}_{p} - {ρ}_{f}\right)}\right)}^{1 / 2}$$

As seen from the above equation, the greater the differences in the density of the particle ρₚ and the density of the fluid ρ_{f}, the more effectively hydrocyclone 100 can separate the particle.

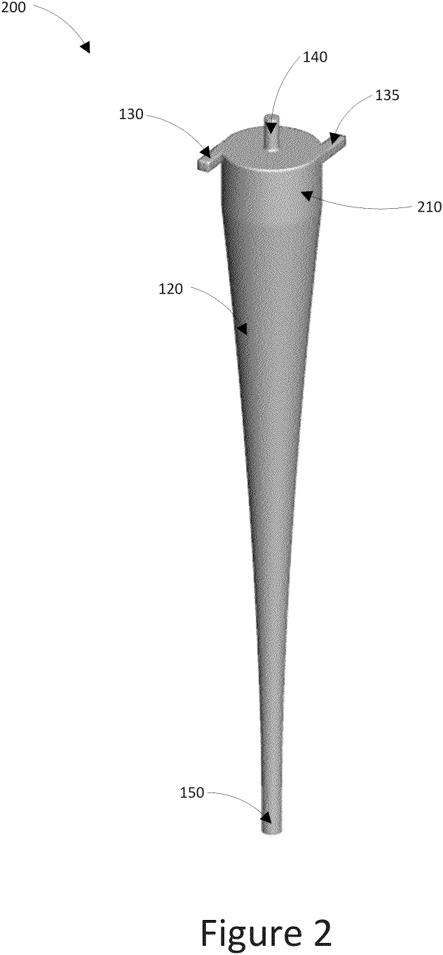

FIG. 2 shows an alternative hydrocyclone 200 according to some embodiments. Hydrocyclone 200 is a single cone hydrocyclone, comprising only a lower conical section 120. Instead of an upper conical section, hydrocyclone 200 comprises an upper cylindrical section 210. Upper cylindrical section 210 and lower conical section 120 are both hollow, and together define a single volume, being fluidly coupled at their intersection.

Hydrocyclone 200 may otherwise be identical to hydrocyclone 100, with upper cylindrical section 210 comprising inlets 130 and 135 and overflow port 140, and lower conical section 120 comprising underflow port 150.

As hydrocyclone 100/200 has no moving parts, its operation is dependent on two main parameters, being the characteristics of the feed stream of fluid being injected into inlets 130/135, and the particular geometry of the hydrocyclone 100/200. The characteristics of the feed stream may include constant physical-chemical properties of the given fluid, such as the density and viscosity of the fluid, the size and density of the particles within the fluid, and the concentration of particles within the fluid. The characteristics of the feed stream may also include variables such as the velocity or flow rate of the fluid, and the percentage of recycling of the underflow.

To enable description of the geometry of hydrocyclone 100/200, FIG. 3 is provided, being a diagram labelling the dimensions of a hydrocyclone 100/200 having a vertical axis 310. As described above with respect to FIGS. 1 and 2, hydrocyclone 100/200 has an upper section 110/210 and a lower section 120. Upper section 110/120 includes at least one inlet 130/135, and an overflow port 140. Upper section 110/120 also comprises a vortex finder 320, connected to overflow port 140. Lower section 120 includes underflow port 150.

The diameter of inlet 130/135 is labelled “a”. The diameter of inlet 130/135 may be between 0.25 and 0.71 mm in some embodiments. According to some embodiments, the diameter of inlet 130/135 may be between 0.25 and 0.6 mm. According to some embodiments, the diameter of inlet 130/135 may be around 0.35 mm.

The diameter of vortex finder 320 and overflow port 140 is labelled Dₓ. The diameter of vortex finder 320 and overflow port 140 may be between 0.075 and 0.75 mm in some embodiments. According to some embodiments, the diameter of vortex finder 320 and overflow port 140 may be between 0.075 and 0.6 mm. According to some embodiments, the diameter of vortex finder 320 and overflow port 140 may be around 0.45 mm.

The length of vortex finder 320 is labelled S. The length of vortex finder 320 may be between 0.5 and 1.67 mm in some embodiments. According to some embodiments, the length of vortex finder 320 may be between 0.5 and 1.5 mm. According to some embodiments, the length of vortex finder 320 may be around 0.84 mm.

The diameter of the body of hydrocyclone 100/200 at upper section 110/210 is labelled D_{c}. The diameter of the body of hydrocyclone 100/200 may be between 0.5 and 5 mm in some embodiments. According to some embodiments, the diameter of the body of hydrocyclone 100/200 may be between 0.5 and 4 mm. According to some embodiments, the diameter of the body of hydrocyclone 100/200 may be around 2.5 mm.

Where the hydrocyclone is a double hydrocyclone 100, the diameter of the body of hydrocyclone 100 at upper section 110 may be given as two measurements, being a diameter of the top surface and a diameter of the bottom surface of the cone. According to some embodiments, the diameter of the top surface of the cone may be around 3.5 mm, and the diameter of the bottom surface of the cone may be around 2.5 mm.

The length of upper section 110/120 is labelled H. The length of upper section 110/120 may be between 1.0 and 3.6 mm in some embodiments. According to some embodiments, the length of upper section 110/120 may be between 1.0 and 3 mm. According to some embodiments, the length of upper section 110/120 may be around 1.8 mm.

The radial distance of the conical surface of lower section 120 from axis 310 is labelled Dᵣ. The value of Dᵣ depends upon the shape of hydrocyclone 100/200, and varies from the top of section 120 to the bottom of section 120.

The diameter of the underflow port 150 is labelled D_{d}. The diameter of the underflow port 150 may be between 0.05 and 1.5 mm according to some embodiments. According to some embodiments, the diameter of the underflow port 150 may be between 0.05 and 0.6 mm. According to some embodiments, the diameter of the underflow port 150 may be around 0.5 mm.

The length of lower section 120 is labelled H_{c}. The length of lower section 120 may be between 2 and 98.6 mm in some embodiments. According to some embodiments, the length of lower section 120 may be between 2 and 37 mm. According to some embodiments, the length of lower section 120 may be around 19.3 mm.

The total length of lower section 120 including the length of underflow port 150 is labelled Ht. According to some embodiments, the length of the underflow port 150 may be around 1 mm. In some embodiments, the length of the underflow port 150 may be between 0.5 mm and 2 mm. The length of lower section 120 may therefore be between 3 and 99.6 mm in some embodiments. According to some embodiments, the total length of lower section 120 including the length of underflow port 150 may be around 20.3 mm.

A table of values for each of the parameters described above, plus further parameters relating to the geometry of hydrocyclone 100/200 and the characteristics of the feed stream, is provided below. Specifically, this table shows the working ranges and the preferred values for each of a range of parameters.

| Parameters | Working ranges | Preferred values |
|---|---|---|
| Body diameter (D_{c}), mm | 0.5-5 | 2.5 |
| Length of the lower section (H_{c}), mm | 2-98.6 | 19.3 |
| Inlet diameter (a), mm | 0.25-0.71 | 0.35 |
| Diameter of overflow (Dₓ), mm | 0.075-0.75 | 0.45 |
| Vortex finder length (S), mm | 0.5-1.67 | 0.84 |
| Underflow diameter (D_{d}), mm | 0.05-1.5 | 0.5 |
| Length of upper section (H), mm | 1.0-3.6 | 1.8 |
| Feed flow rate, mL/s | 3-66 | 66 |
| Inlet velocity, m/s | 8-40 | 9.6 |
| Cone shape (n) | 0.6-1.4 | 0.6, 1 |
| Surface roughness, µm | 0-10 | <10 |
| Cone number | 1 or 2 | 2 |

The feed flowrate and the inlet velocity may be inter-dependent, and the feed flowrate may vary based on the inlet velocity. According to some embodiments, the feed flowrate may be the area of the inlet multiplied by the inlet velocity. According to some embodiments, the feed flowrate may be between 3 and 66 mL/s. According to some embodiments, the feed flowrate may be between 10 and 66 mL/s. In some embodiments, the feed flow rate may be around 66 mL/s. The inlet velocity may be between 8 and 40 m/s in some embodiments. According to some embodiments, the inlet velocity may be between 9.6 and 16.25 m/s. According to some embodiments, the inlet velocity may be around 9.6 m/s.

Increasing the flow rate and the inlet velocity within a hydrocyclone generally changes the separation efficiency and increases the amount of fluid being expelled from the underflow. The separation efficiency increases with increasing flowrate initially at low flowrate range, but then decreases when the flow rate increases further due to increasing the turbulence of the fluid within the hydrocyclone. Specifically, increasing the inlet velocity at a high flowrate will increase the Reynolds number and the tangential velocity of the fluid within the hydrocyclone, resulting in stronger turbulence and decreasing the separation efficiency at a high flow rate regime. In contrast, at a lower flowrate increasing the inlet velocity results in a higher tangential velocity which increases the centrifugal force, and hence improves the separation efficiency

However, hydrocyclone 100/200 allows for a higher flowrate to be possible by creating regions of laminar flow within the body of hydrocyclone 100/200, based on the geometry as described above.

The cone shape (n) is a value describing the level of convexity or concavity of lower section 120. Specifically, a cone shape value of 1 corresponds to lower section 120 having flat walls exhibiting no convexity or concavity; a cone shape value of less than 1 corresponds to lower section 120 having concave walls; and a cone shape value of more than 1 corresponds to lower section 120 having convex walls.

The cone shape value may be determined according to the following equation:

$$\frac{L - \left(H + {H}_{t}\right)}{L - H} = {\left(\frac{2 {D}_{r} - {D}_{d}}{{D}_{c} - {D}_{d}}\right)}^{n}$$

Where L is the total length of hydrocyclone 100/200, including the overflow 140 and the underflow 150.

The cone shape may be between 0.6 and 1.4 in some embodiments. According to some embodiments, the cone shape may be below 1. According to some embodiments, the cone shape may be between 0.6 and 1. In some embodiments, the cone shape may be around 0.6.

The surface roughness of the inside of hydrocyclone 100/200 may be between 0 and 10 µm in some embodiments. According to some embodiments, the surface roughness of the inside of hydrocyclone 100/200 may be around 3 µm. The surface roughness may depend on manufacturing methods and materials used. According to some embodiments, hydrocyclone 100/200 may be manufactured by 3D printing, which may affect the surface roughness. In some embodiments, hydrocyclone 100/200 may be manufactured by drilling or welding. According to some embodiments, hydrocyclone 100/200 may be manufactured of metal or plastic. For example, hydrocyclone 100/200 may be manufactured of acrylonitrile butadiene styrene (ABS) plastic, polylactic acid (PLA), polyamide or nylon, glass filled polyamide, stereolithography materials such as epoxy resins, titanium, stainless steel, photopolymers, polycarbonate, ceramics, high impact polystyrene, or synthetic polymers such as polyethylene glycol or polyvinyl alcohol, for example. Where hydrocyclone 100/200 is to be used to process biological samples, hydrocyclone 100/200 may be manufactured of materials sterilised by or suitable to be sterilised by gamma radiation. The materials may be specifically suitable for handling biological samples. According to some embodiments, hydrocyclone 100/200 may be manufactured of materials that are in accordance with good manufacturing practice (GMP) regulations.

The cone number represents whether the upper section 110/210 of hydrocyclone 100/200 is conical in shape. Where the cone number is 1, the upper section is cylindrical, corresponding to upper section 210 of hydrocyclone 200 as shown in FIG. 2. Where the cone number is 2, the upper section is conical, corresponding to upper section 110 of hydrocyclone 100 as shown in FIG. 1.

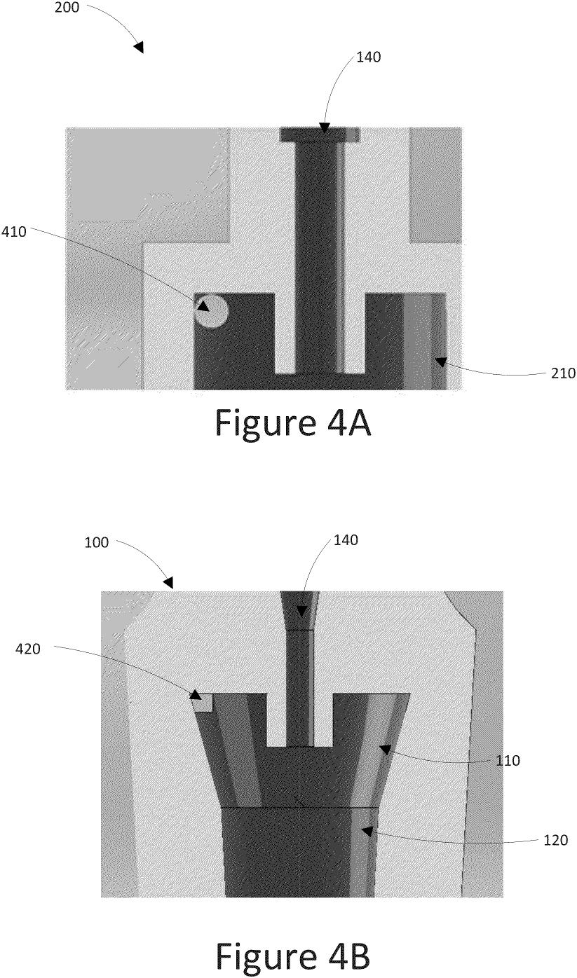

A further factor affecting the operation of hydrocyclone 100/200 is the shape of inlets 130/135. FIGS. 4A and 4B show two example inlet shapes. FIG. 4A shows a hydrocyclone 200 having an upper section 210 and an overflow port 140. Upper section 210 defines a circular inlet 410. FIG. 4B shows a hydrocyclone 100 having an upper section 110 and an overflow port 140. Upper section 110 defines a trapezoidal inlet 420. In practice, either of hydrocyclones 100 or 200 could be manufactured with either a circular or a trapezoidal inlet ports 130/135.

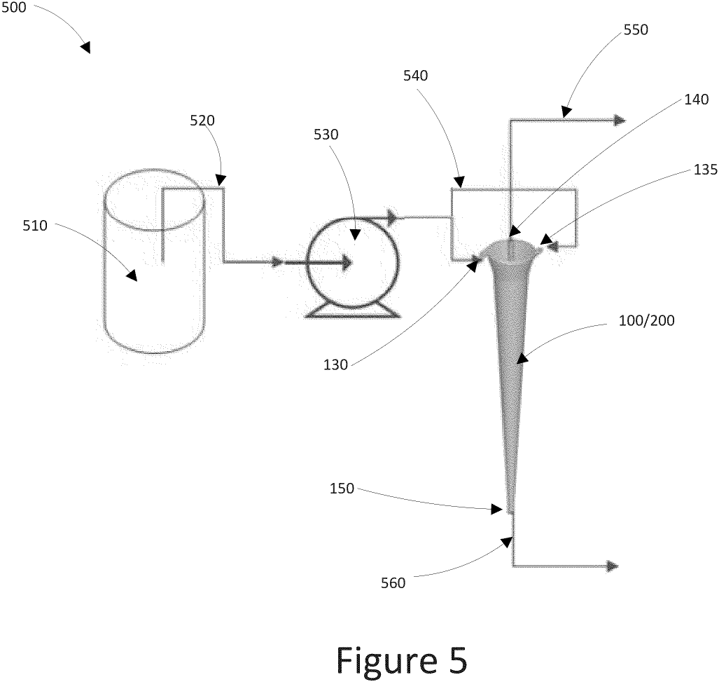

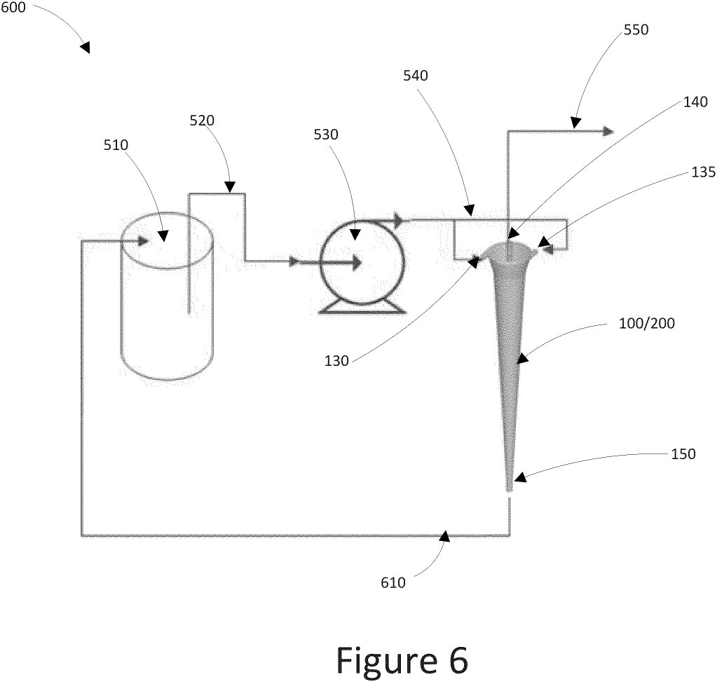

According to some embodiments, the operation of a hydrocyclone 100/200 may be improved when the fluid exiting the underflow port 150 is recycled. FIGS. 5 and 6 show example systems incorporating hydrocyclone 100/200, with FIG. 5 showing a system 500 that does not incorporate recycling, and FIG. 6 showing a system 600 incorporating recycling.

FIG. 5 shows a processing system 500 for isolating particles incorporating hydrocyclone 100/200. Processing system 500 comprises a feed tank 510 for holding a fluid from which particles, such as microparticles or nanoparticles, are to be isolated.

Processing system 500 may be configured to operate at temperatures between 0 and 50° C. According to some embodiment, processing system 500 may be configured to operate at temperatures between 10 and 30° C. According to some embodiments, processing system 500 may be configured to operate at temperatures of around 25° C. As the viscosity of fluids decreases with higher temperatures, and as lower viscosity fluids result in higher separation efficiency, according to some embodiments system 500 may be configured to operate at a temperature as high as possible without damaging or causing denaturation of the fluid or sample being processed.

The fluid is drawn through a tube 520 from feed tank 510 into the inlet 130/135 of hydrocyclone 100/200 by a pump 530, which may be a gear pump in some embodiments. Pump 530 may be configured to pressurise the fluid to aid the movement of the fluid by mechanical action.

From pump 530, the fluid is pumped into inlets 130/135 of hydrocyclone 100/200. The smaller, lighter and/or less dense particles are isolated and exit out of overflow port 140 into tube 550 for collection and further processing, while the remaining particles and fluid exit from underflow port 150 and into tube 560, and are then discarded. For example, according to some embodiments, nanoparticles may be isolated and exit from overflow port 140, while microparticles may exit from underflow port 150. According to some embodiments, rather than being discarded, the particles and fluid exiting from underflow port 150 may be retained for further processing. System 500 may operate as a continuous flow system.

FIG. 6 shows an alternative processing system 600 for isolating particles incorporating hydrocyclone 100/200. Processing system 600 also comprises a feed tank 510 for holding a fluid from which particles, such as microparticles or nanoparticles, are to be isolated. The fluid is drawn from feed tank 510 through a tube 520 into inlets 130/135 of hydrocyclone 100/200 by a pump 530. The smaller, lighter and/or less dense particles are isolated and exit out of overflow port 140 into tube 550 for collection and further processing, while the remaining particles and fluid exit from underflow port 150. However, instead of being discarded, the underflow port 150 is connected to tube 610 which channels the remaining particles and fluid back into feed tank 510, and at least a percentage of the particles and fluid are mixed and re-cycled through system 600. Any smaller and lighter particles that remain in the fluid can therefore be isolated in a subsequent cycle. The percentage of remaining particles and fluid that are recycled may be varied based on a recycling ratio. By increasing the amount of fluid that is recycled, the fluid taken from the overflow is decreased by a factor of the recycling ratio.

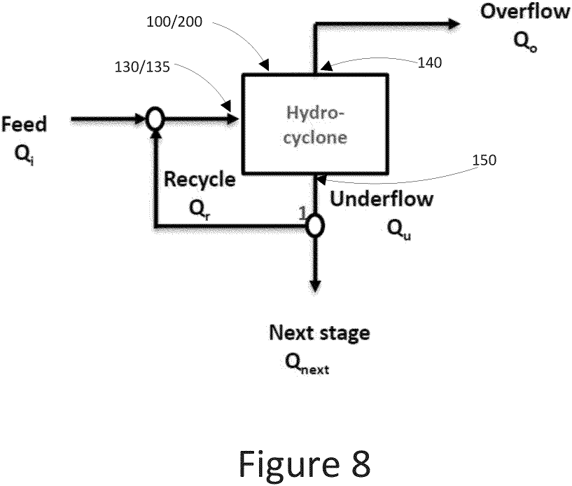

The recycling ratio of hydrocyclone 100/200 is described in further detail with reference to FIG. 8. As shown in FIG. 8, the flowrate of the fluid exiting overflow port 140 is defined as Qₒ, and the flowrate of the inlet(s) 130/135 are defined as Qᵢ. The flowrate of fluid exiting underflow port 150 is defined as Qᵤ, and may be split into two streams, being a recycling stream Qᵣ and a next stage stream Qₙₑₓₜ. The recycling ratio R is defined as the fraction of the fluid exiting underflow port 150 that is recycled back to inlet 130/135 via recycling stream Qᵣ:

$$R = \frac{{Q}_{r}}{{Q}_{u}}$$

The overall mass balance of the system is defined by the equation:

$${Q}_{i} + {Q}_{r} = {Q}_{o} + {Q}_{n e x t}$$

The mass balance around point 1 of FIG. 8 is defined by the equation:

$${Q}_{u} = {Q}_{r} + {Q}_{n e x t}$$

The recycling ratio can therefore only affect Qₙₑₓₜ. Qᵤ and the split ratio of hydrocyclone 100/200 remain unaffected.

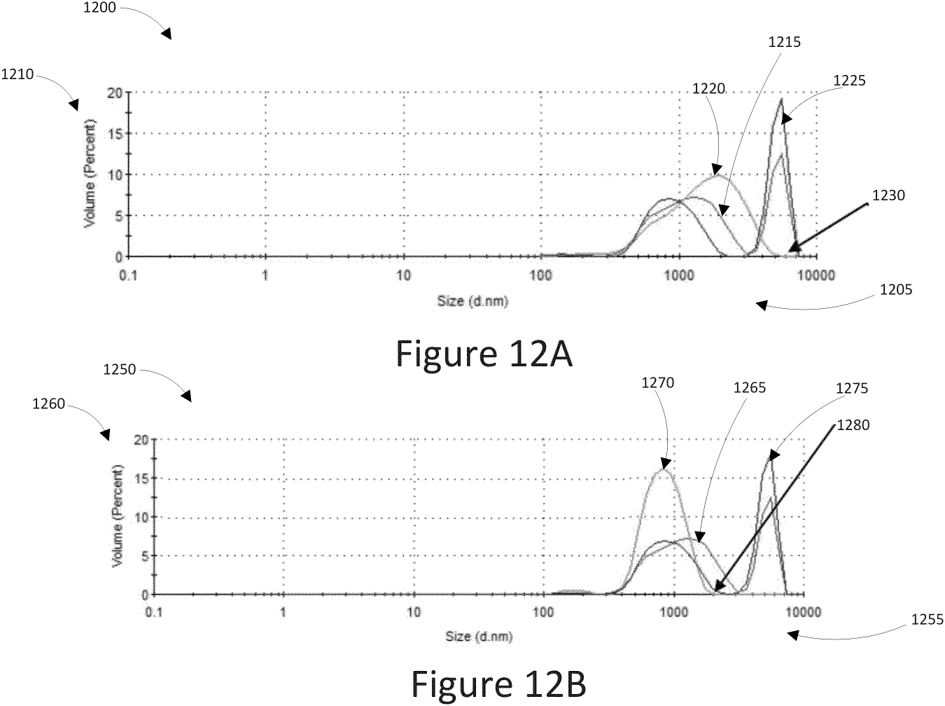

The effect of recycling using a system such as system 600 is shown in FIGS. 12A and 12B.

FIG. 12A shows a graph 1200 showing the results of using a system without underflow recycling, such as system 500, with a hydrocyclone 100 to isolate micron-sized particles from an exosome source. Specifically, FIG. 12A shows the volume of various sized particles identified in the feed, underflow and overflow of a hydrocyclone 100 when processing whey.

Hydrocyclone 100 as used for the experiment demonstrated in FIG. 12A has a body diameter (D_{c}) of 2.5 mm, cone number 2, cone shape (n) of 1, length of the lower section (H_{c}) of 19.3 mm, inlet diameter (a) of 0.35 mm, diameter of overflow (Dₓ) of 0.45 mm, vortex finder length (S) of 0.84 mm, underflow diameter (D_{d}) of 0.5 mm, and length of the upper section (H) of 1.8 mm.

During processing, the actual feed flowrate was measured as 132.2 mL/min with a flowrate of 66.1 mL/min at each inlet 130/135.

Dynamic light scattering was performed on the feed, overflow and underflow fluid, to determine the sizes of particles present. The results of this analysis are shown in graph 1200 of FIG. 12A. After processing, the volume contribution of the overflow fluid was 33.5% of the initial feed volume, with the volume contribution of the underflow volume making up the remaining 66.5% of the initial feed volume.

Graph 1200 has an x-axis 1205 illustrating the size or diameter in nm of the identified particles, and a y-axis 1210 showing the volume as a percentage of the identified particles within each fluid. Line 1215 represents the particles identified in the feed fluid, line 1220 represents the particles identified in the overflow fluid and line 1225 represents the particles identified in the underflow fluid. Arrow 1230 shows the cut-off size for particles identified in the overflow, being around 5 µm.

In contrast, FIG. 12B shows a graph 1250 showing the results of using a system with underflow recycling, such as system 600, with a hydrocyclone 100 to isolate micron-sized particles from an exosome source. Specifically, FIG. 12B shows the volume of various sized particles identified in the feed, underflow and overflow of hydrocyclone 100 when processing whey.

Hydrocyclone 100 as used for the experiment demonstrated in FIG. 12B has a body diameter (D_{c}) of 2.5 mm, cone number 2, cone shape (n) of 1, length of the lower section (H_{c}) of 19.3 mm, inlet diameter (a) of 0.35 mm, diameter of overflow (Dₓ) of 0.45 mm, vortex finder length (S) of 0.84 mm, underflow diameter (D_{d}) of 0.5 mm, and length of the upper section (H) of 1.8 mm.

During processing, the actual feed flowrate was measured as 132.2 mL/min with a flowrate of 66.1 mL/min at each inlet 130/135.

Dynamic light scattering was performed on the feed, overflow and underflow fluid, to determine the sizes of particles present. The results of this analysis are shown in graph 1250 of FIG. 12B. After processing, the volume contribution of the overflow fluid was 32.5% of the initial feed volume, with the volume contribution of the underflow volume making up the remaining 67.5% of the initial feed volume.

Graph 1250 has an x-axis 1255 illustrating the size or diameter in nm of the identified particles, and a y-axis 1260 showing the volume as a percentage of the identified particles within each fluid. Line 1265 represents the particles identified in the feed fluid, line 1270 represents the particles identified in the overflow fluid and line 1275 represents the particles identified in the underflow fluid. Arrow 1280 shows the cut-off size for particles identified in the overflow, being around 2 µm.

As apparent from a comparison between graphs 1200 and 1250, recycling using a system such as system 600 improves the separation produced by hydrocyclone 100.

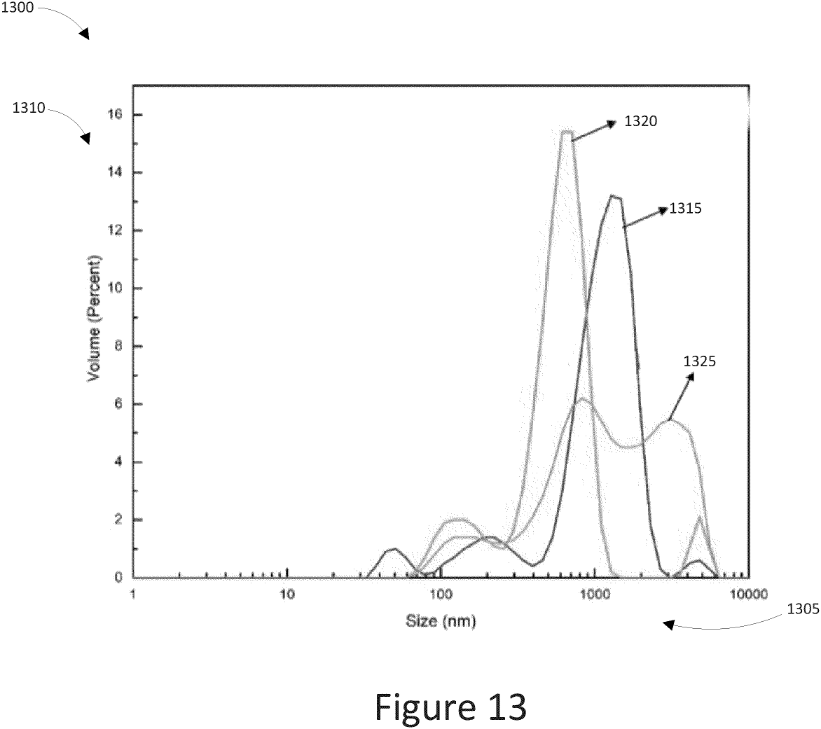

A further example of using hydrocyclone 100 with recycling is shown in FIG. 13. FIG. 13 shows a graph 1300 showing the results of using a system with underflow recycling such as system 600 with a hydrocyclone 100 to isolate micron-sized particles from an exosome source. Specifically, FIG. 13 shows the volume of various sized particles identified in the feed, underflow and overflow of hydrocyclone 100 when processing whey.

During processing, the actual feed flowrate was measured as 150 mL/min with a flowrate of 75 mL/min at each inlet 130/135. The whey was processed with recycling of the underflow for a processing time of 4 minutes.

Dynamic light scattering was performed on the feed, overflow and underflow fluid, to determine the sizes of particles present. The results of this analysis are shown in graph 1300 of FIG. 13. After processing, the volume contribution of the overflow fluid was 58.38% of the initial feed volume, with the volume contribution of the underflow volume making up the remaining 41.61% of the initial feed volume.

Graph 1300 has an x-axis 1305 illustrating the size or diameter in nm of the identified particles, and a y-axis 1310 showing the volume as a percentage of the identified particles within each fluid. Line 1315 represents the particles identified in the feed fluid, line 1320 represents the particles identified in the overflow fluid and line 1325 represents the particles identified in the underflow fluid.

As apparent from the graph, large particles bigger than 5 µm were successfully separated using hydrocyclone 100. These results show that the hydrocyclone 100 when used with recycling can be used to successfully isolate particles larger than 5 µm in diameter.

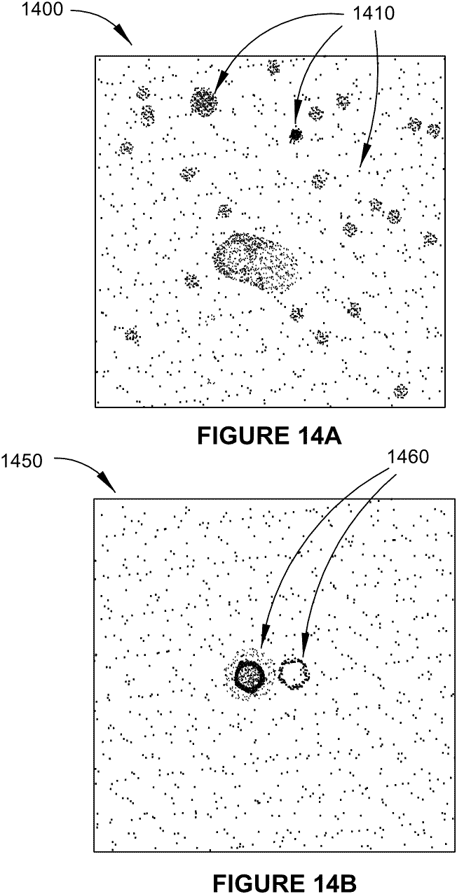

The results of graph 1300 are also demonstrated by FIGS. 14A and 14B, which show transmission electron microscope (TEM) images of the feed stream and the overflow stream of the hydrocyclone used in the FIG. 13 experiment, respectively.

FIG. 14A shows a TEM image 1400 of the feed stream comprising whey, magnified to 200 nm. Particles 1410 of various size distributions can be observed in the image.

FIG. 14B shows a TEM image 1450 of the overflow stream, magnified to 100 nm. Exosomes 1460 in the range of around 40 to 180 nm can be observed in the image. This image confirms the presence of exosomes 1460 in the overflow stream, confirming that hydrocyclone 100 can be used to isolate exosomes from whey.

The operation of hydrocyclone 100 can also be used to isolate or purify particles from a range of fluids.

According to some embodiments, the fluid may comprise a biological fluid or a fraction thereof, or a fluid containing biological material such as processed foods. Examples of such fluids include, but are not limited to, milk, whey, plant extract, serum, blood, plasma, fermented products such as beer, fruit juice, fruit pulp, saliva, tears, sperm, urine, faeces, cerebrospinal fluid, interstitial liquid, synovial liquid, an isolated fluid from bone marrow, a mucus or fluid from the respiratory, intestinal or Benito-urinary tract, waste water, cell extracts, cell or tissue extracts, culture media or similar comprising particles secreted from cells (or both cells and particles secreted therefrom) such as extracellular vesicles (for example exosomes), viruses, proteins (such as antibodies or proteins/peptides for vaccine production) and nucleic acids. The secreted or extracted particles can be from any type of cell such as, but not limited to, a mammalian cell, an insect cell, a plant cell, an avian cell, an algal cell, a bacterial cell or a fungal cell.

According to some embodiments, the fluid may comprise a non-biological fluid, such as water, air, glycerol, exhaust gases, petrochemicals, chemical solutions, oil-water emulsions, starch solutions, ethanol, diesel and other fluids. This may be useful in industries such as food processing industries, mining industries, and waste-water treatment industries, for example.

According to some embodiments, the fluid has a density of less than 1.5 g/cc. According to some embodiments, the fluid has a density of less than 1.3 g/cc.

In some embodiments, the particles comprise one or more of a liposome, cell (such as a mammalian cell, a microbial cell or a HeLa cell), secreted extracellular vesicle (such as an exosome), virus (such as a mammalian virus), virus particle (or virion), viral vector, virus-like particle, protein (such as antibodies or proteins/peptides for vaccine production, or whey particles), protein aggregate, nucleic acid, nucleic acid aggregate, DNA, RNA, biotherapeutic particle, or any combination thereof. Whilst the isolated cell can be an animal cell, the isolated cell may also be a smaller cell such as an algal cell, a bacterial cell (such as E.coli), or a fungal cell (such as a yeast cell). The particle may also be one or more of an oil particle, grease particle, starch particle, silica particle, PMMA particle, polustyrene latex (PSL) particle, micro-bead particle, and a sludge particle, for example. According to some embodiments, hydrocyclone 100/200 may be configured to isolate some particle types but not others. For example, according to some embodiments, hydrocyclone 100/200 may be configured to isolate exosome particles, but not oleosome particles.

According to some embodiments, a particle isolated using hydrocyclone 100/200 is less than 40 µm, less than 20 µm, less than 10 µm, less than 5 µm or less than 1 µm in size.

According to some embodiments, a particle isolated using hydrocyclone 100/200 has a density of between 0.5 and 2.5 g/cc. According to some embodiments, a particle isolated using hydrocyclone 100/200 has a density of between 0.7 and 2.0 g/cc. According to some embodiments, a particle isolated using hydrocyclone 100/200 has a density of between 1.0 and 2.0 g/cc.

According to some embodiments, a particle may be isolated from a fluid using hydrocyclone 100/200 if the density of the fluid is lower than the density of the particle.

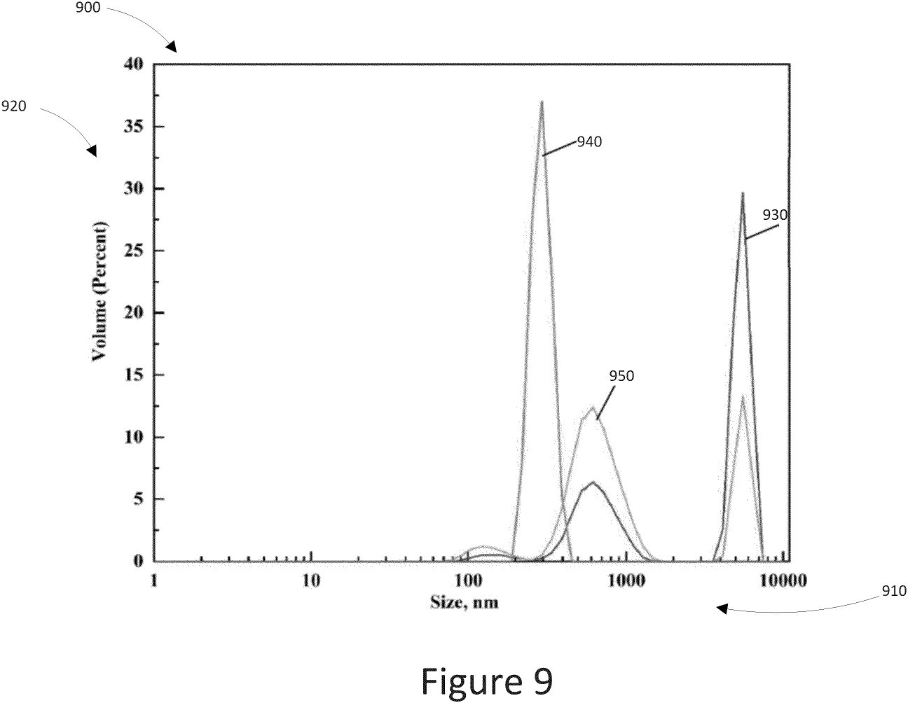

A graph 900 showing the results of using hydrocyclone 100 to isolate micron-sized particles from an exosome source is shown in FIG. 9. Hydrocyclone 100 as used for the experiment demonstrated in FIG. 9 has a body diameter (D_{c}) of 2.5 mm, cone number 2, cone shape (n) of 1, length of the lower section (H_{c}) of 19.3 mm, inlet diameter (a) of 0.35 mm, diameter of overflow (Dₓ) of 0.45 mm, vortex finder length (S) of 0.84 mm, underflow diameter (D_{d}) of 0.5 mm, and length of the upper section (H) of 1.8 mm.

Specifically, FIG. 9 shows the volume of various sized particles identified in the feed, underflow and overflow of hydrocyclone 100 when processing ginger juice.

The ginger juice used to produce the results demonstrated in graph 900 was obtained by starting with a quantity of ginger, from which the skin was peeled and which was washed to remove any dirt or contaminants on the surface. The peeled ginger was soaked in a 10 mM phosphate buffer having a pH of 8 for 30 minutes. The ginger was then finely grated, and the juice extracted. The juice was subsequently passed through mesh to strain away any remaining solids and fibers. The strained juice was used as a feed liquid for a hydrocyclone 100 within a processing system such as processing system 500. The actual feed flowrate was measured as 240 mL/min with a flowrate of 120 mL/min at each inlet 130/135. The ginger juice was processed for a processing time of 2 minutes.

Dynamic light scattering was performed on the feed, overflow and underflow fluid, to determine the sizes of particles present. The results of this analysis are shown in graph 900 of FIG. 9. After processing, the volume contribution of the overflow fluid was 37.9% of the initial feed volume, with the volume contribution of the underflow volume making up the remaining 62.1% of the initial feed volume.

Graph 900 has an x-axis 910 illustrating the size or diameter in nm of the identified particles, and a y-axis 920 showing the volume as a percentage of the identified particles within each fluid. Line 930 represents the particles identified in the feed fluid, line 940 represents the particles identified in the overflow fluid and line 950 represents the particles identified in the underflow fluid.

As apparent from the graph, the majority of the volume of the identified particles from the feed fluid were between 3500 to 7500 nm in size, with a smaller amount being between 300 and 1500 nm and a smaller yet volume being between 100 and 200 nm. In the overflow fluid, almost all of identified particles were between 200 nm and 450 nm. In the underflow fluid, equal proportions of the volume were particles of between 4000 and 7500 nm in size, and particles of between 250 and 1500 in size, with some identified particles being between 80 and 250 nm in size.

These results show that the hydrocyclone 100 can be used to successfully isolate particles larger than 1 µm in diameter.

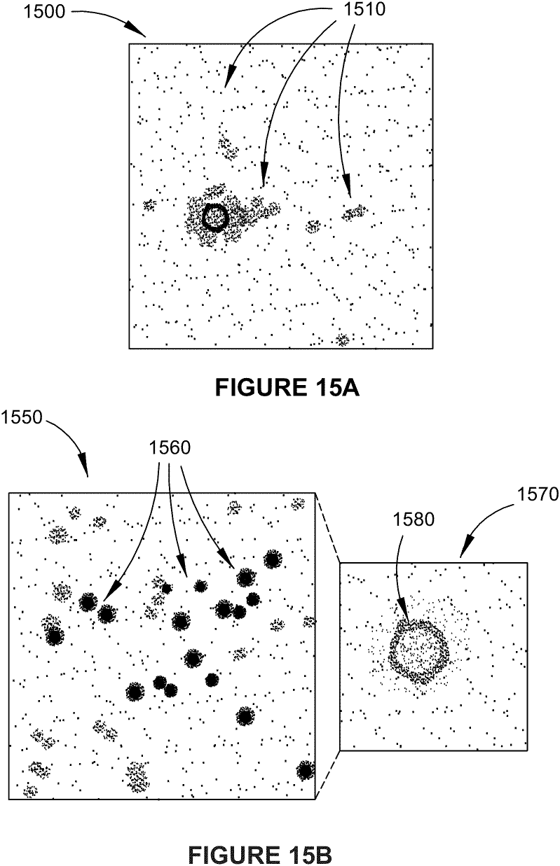

The results of graph 900 are also demonstrated by FIGS. 15A and 15B, which show transmission electron microscope (TEM) images of the feed stream and the overflow stream of the hydrocyclone used in the FIG. 9 experiment, respectively.

FIG. 15A shows a TEM image 1500 of the feed stream comprising ginger juice, magnified to 200 nm. Particles 1510 of various size distributions can be observed in the image.

FIG. 15B shows a TEM image 1550 of the overflow stream from hydrocyclone 100, magnified to 100 nm. Exosomes 1560 in the range of around 37 to 91 nm can be observed in the image. Insert image 1570 shows an exosome 1580 magnified further to 50 nm. These images confirm the presence of exosomes 1560/1580 in the overflow stream, confirming that hydrocyclone 100 can be used to isolate exosomes from ginger juice.

According to some embodiments, hydrocyclone 100/200 may be operated in series with one or more additional hydrocyclones 100/200, which may further improve the separation produced.

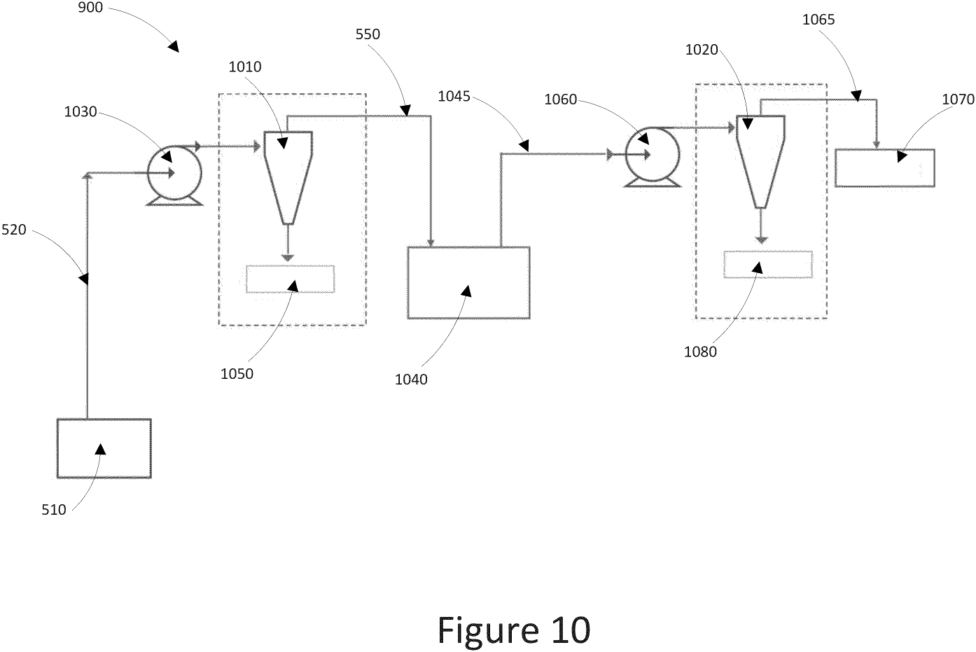

FIG. 10 shows a processing system 1000 for isolating particles incorporating two hydrocyclone 100/200 in series. Specifically, system 1000 includes a first hydrocyclone 1010 and a second hydrocyclone 1020.

Processing system 1000 further comprises a feed tank 510 for holding a fluid from which particles, such as microparticles or nanoparticles, are to be isolated, as described above with reference to FIG. 5. Like processing system 500, processing system 1000 may be configured to operate at temperatures between 0 and 50° C. According to some embodiment, processing system 1000 may be configured to operate at temperatures between 10 and 30° C. According to some embodiments, processing system 1000 may be configured to operate at temperatures of around 25° C. As the viscosity of fluids decreases with higher temperatures, and as lower viscosity fluids result in higher separation efficiency, according to some embodiments system 1000 may be configured to operate at a temperature as high as possible without damaging or causing denaturation of the fluid or sample being processed.

The fluid is drawn through a tube 520 from feed tank 510 into the inlet 130/135 of the first hydrocyclone 1010 by a pump 1030, which may be a pump such as pump 530 as described above with reference to FIG. 5.

From pump 1030, the fluid is pumped into inlets 130/135 of hydrocyclone 1010. The smaller, lighter and/or less dense particles are isolated and exit out of overflow port 140 into tube 550 and subsequently overflow tank 1040 for collection and further processing, while the remaining larger particles and fluid exit from underflow port 150 and into underflow collection tank 1050.

The fluid from overflow tank 1040 is further processed, being is drawn through a tube 1045 from overflow tank 1040 into the inlet 130/135 of the second hydrocyclone 1020 by a second pump 1060, which may be a pump such as pump 530 as described above with reference to FIG. 5.

From pump 1060, the fluid is pumped into inlets 130/135 of hydrocyclone 1020. The smaller, lighter and/or less dense particles are isolated and exit out of overflow port 140 into tube 1065 for collection and further processing, while the remaining particles and fluid exit from underflow port 150 and into second underflow collection tank 1080.

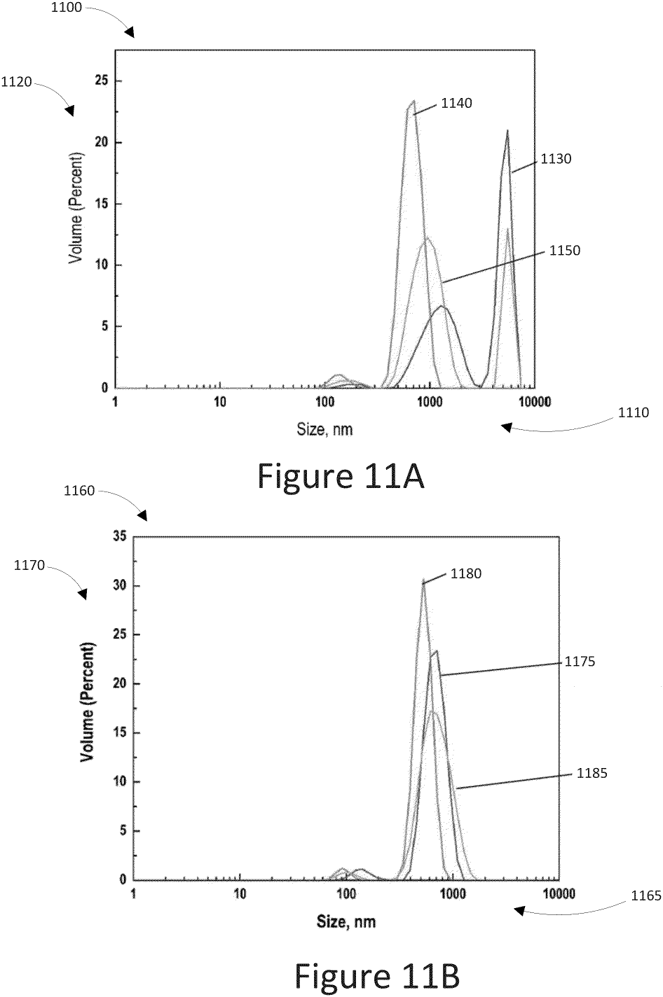

FIGS. 11A and 11B demonstrate the results of using system 1000 to isolate particles from an exosome source. Specifically, FIGS. 11A and 11B show the volume of various sized particles identified in the feed, underflow and overflow of hydrocyclones 1010 and 1020 when processing whey, as determined using dynamic light scattering.

For the experiments shown in FIGS. 11A and 11B, hydrocyclone 1010 and hydrocyclones 1020 were both double cone hydrocyclones as described above with reference to hydrocyclone 100, and were of substantially identical shape and size. Hydrocyclones 1010 and 1020 both have a body diameter (D_{c}) of 2.5 mm, cone number of 2, cone shape (n) of 1, length of the lower section (H_{c}) of 19.3 mm, inlet diameter (a) of 0.35 mm, diameter of overflow (Dₓ) of 0.45 mm, vortex finder length (S) of 0.84 mm, underflow diameter (D_{d}) of 0.5 mm, and length of the upper section (H) of 1.8 mm.

FIG. 11A shows a graph 1100 illustrating the results after processing the whey with first hydrocyclone 1010 within a processing system such as processing system 1000. The pump flowrate produced by pump 1030 was set at 150 mL/min, and the actual flowrate was measured as 120 mL/min in total, or 60 mL/min at each inlet 130/135.

After processing, the volume contribution of the overflow fluid was 57% of the initial feed volume, with the volume contribution of the underflow volume making up the remaining 43% of the initial feed volume.

Graph 1100 has an x-axis 1110 illustrating the size or diameter in nm of the identified particles, and a y-axis 1120 showing the volume as a percentage of the identified particles within each fluid. Line 1130 represents the particles identified in the feed fluid, line 1140 represents the particles identified in the overflow fluid and line 1150 represents the particles identified in the underflow fluid.

As apparent from the graph, the majority of the volume of the identified particles from the feed fluid were between 4000 to 7500 nm in size, with a smaller amount being between 400 and 1500 nm and a smaller yet volume being between 100 and 300 nm. In the overflow fluid, the majority of identified particles were between 350 nm and 1500 nm. In the underflow fluid, equal proportions of the volume were particles of between 4000 and 7500 nm in size, and particles of between 350 and 2000 in size, with some identified particles being between 100 and 200 nm in size.

FIG. 11B shows a graph 1160 illustrating the results after subsequently processing the whey liquid output from the overflow fluid of hydrocyclone 1010 with second hydrocyclone 1020 within a processing system such as processing system 1000. The pump flowrate produced by pump 1060 was set at 150 mL/min, and the actual flowrate was measured as 120 mL/min in total, or 60 mL/min at each inlet 130/135.

After processing, the volume contribution of the overflow fluid was 17.4% of the initial feed volume, with the volume contribution of the underflow volume making up 22% of the initial feed volume.

Graph 1160 has an x-axis 1165 illustrating the size or diameter in nm of the identified particles, and a y-axis 1170 showing the volume as a percentage of the identified particles within each fluid. Line 1175 represents the particles identified in the feed fluid, line 1180 represents the particles identified in the overflow fluid and line 1185 represents the particles identified in the underflow fluid.

As apparent from the graph, the majority of the volume of the identified particles from the feed fluid were between 300 to 2000 nm in size, with a smaller amount being between 100 and 200 nm. In the overflow fluid, the majority of identified particles were between 150 nm and 1100 nm, with a smaller amount being between 70 and 150 nm. In the underflow fluid, the majority of identified particles were between 150 nm and 2000 nm, with a smaller amount being between 70 and 150 nm

As apparent based on a comparison between graphs 1100 and 1160, using two hydrocyclones 100 in series as shown in FIG. 10 resulted in an improvement in particle separation, as further particles were able to be isolated when the overflow fluid was processed a second time.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A hydrocyclone for isolating particles within a fluid, the hydrocyclone comprising:
an upper conical section defining at least one inlet to receive the fluid, a vortex finder extending into the upper conical section, and an overflow port fluidly connected to the vortex finder and configured to expel a portion of the fluid out of the upper conical section; and
a lower conical section defining an underflow port to expel the remaining fluid out of the lower conical section, the lower conical section being fluidly connected to the upper conical section to define a single hollow volume;
wherein the walls of the lower conical section are concave; and
wherein the shape of the hydrocyclone causes particles smaller than a predetermined size to be isolated by expelling the particles from the overflow port.

2. The hydrocyclone of claim 1, wherein the predetermined size is less than 5 µm.

3. The hydrocyclone of claim 2, wherein the predetermined size is less than 1 µm.

4. The hydrocyclone of any one of claims 1 to 3, wherein the shape of the hydrocyclone causes particles larger than the predetermined size to be expelled from the underflow port.

5. The hydrocyclone of any one of claims 1 to 4, wherein the diameter of the hydrocyclone is between 0.5 mm and 5 mm.

6. The hydrocyclone of any one of claims 1 to 5, wherein the upper conical section defines two counter-disposed inlets to receive the fluid.

7. The hydrocyclone of any one of claims 1 to 6, where the diameter of the at least one inlet is between 0.25 and 0.71 mm.

8. The hydrocyclone of any one of claims 1 to 7, where the diameter of the overflow port is between 0.075 and 0.75 mm.

9. The hydrocyclone of any one of claims 1 to 8, where the length of the vortex finder is between 0.5 and 1.67 mm.

10. The hydrocyclone of any one of claims 1 to 9, where the length of the upper conical section is between 1.0 and 3.6 mm.

11. The hydrocyclone of any one of claims 1 to 10, where the diameter of the underflow port is between 0.05 and 1.5 mm.

12. The hydrocyclone of any one of claims 1 to 11, where the length of the lower conical section is between 2 and 98.6 mm.

13. The hydrocyclone of any one of claims 1 to 12, wherein the cone shape of the lower conical section is between 0.6 and 1.

14. The hydrocyclone of any one of claims 1 to 13, wherein a roughness of the inside of the hydrocyclone is between 3 and 10 µm.

15. The hydrocyclone of any one of claims 1 to 14, wherein the at least one inlet is circular in shape.

16. The hydrocyclone of any one of claims 1 to 14, wherein the at least one inlet is trapezoidal in shape.

17. The hydrocyclone of any one of claims 1 to 16, wherein the hydrocyclone is manufactured by 3D printing.

18. The hydrocyclone of any one of claims 1 to 17, wherein the fluid comprises a biological fluid or a fraction thereof or contains biological material.

19. The hydrocyclone of any one of claims 1 to 18, wherein the particles comprise at least one of a nanoparticle, a liposome, a cell, a secreted extracellular vesicle, virus particle, viral vector, virus-lie particle, protein aggregate, nucleic acid aggregate, or any combination thereof.

20. The hydrocyclone of claim 19, wherein the secreted extracellular vesicle is an exosome.

21. A system for isolating particles within a fluid, the system comprising:
a feed tank for holding a fluid;
the hydrocyclone of any one of claims 1 to 20; and
a pump for receiving the fluid from the feed tank and pumping the fluid into the hydrocyclone.

22. The system of claim 21, wherein the system further comprises a recycling tube for channelling fluid from the underflow port of the hydrocyclone into the feed tank.

23. The system of claim 21 or claim 22, wherein the pump is configured to pump the fluid into the hydrocyclone at a velocity between 9.6 and 16.25 m/s.

24. A method for isolating particles within a fluid, the method comprising:
pumping fluid into the at least one inlet of the hydrocyclone of any one of claims 1 to 20; and
collecting the isolated particles from the overflow port of the hydrocyclone.

25. The method of claim 24, wherein pumping fluid into the at least one inlet of the hydrocyclone comprises pumping fluid into the at least one inlet of the hydrocyclone at a velocity between 9.6 and 16.25 m/s.

26. The method of claim 24 or claim 25, further comprising collecting fluid from the underflow port of the hydrocyclone, and subsequently re-pumping the collected fluid into at least one inlet of the hydrocyclone or into the feed tank.
